(19) United States
(12) Patent Application Publication
(10) Pub. No.: US 2005/0257585 A1
(43) Pub. Date: Nov. 24, 2005

(54) Process For Capturing Heat From Aerobic Compost

(75) Inventor: John A. Crockett, Carmel, NY (US)

Correspondence Address: John A. Crockett, 24 Sol Drive, Carmel, NY, 10512-5039, US

(73) Assignee: John A. Crockett, Carmel, NY (US)

(21) Appl. No.: 10/708,254

(22) Filed: May 21, 2004

(51) Int. Cl. C05F 11/08

(52) U.S. Cl. 71/6

(57) ABSTRACT

A method for capturing the Surplus Microbial Metabolic Heat from aerobic composting by routing the off-gas from forced aeration, through a heat exchanger, with means of regulating the flow rate of the forced to aeration balance with the rate of Surplus Microbial Metabolic Heat being generated by the microbes doing the composting, and drains to let out condensate from the cooling off-gas.

### BACKGROUND OF INVENTION

While many people have recognized that compost heats and that it would be nice to be able to capture and harness that heat, the problem has been how to efficiently capture the surplus microbial metabolic heat from the compost. The claimed invention solves that problem, capturing nearly all the Surplus Microbial Metabolic Heat from the compost.

### SUMMARY OF INVENTION

The Invention is a process, to capture the surplus microbial metabolic heat from active aerobic compost by routing the hot off-gas from forced aeration which has gone through the active compost, through a heat exchanger.

### BRIEF DESCRIPTION OF DRAWINGS

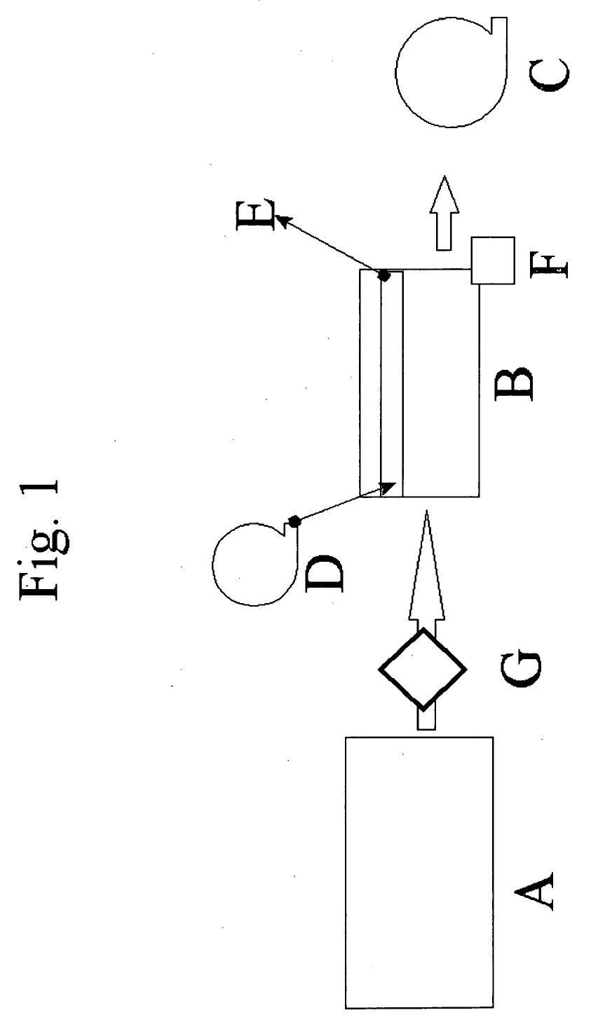

In FIG. 1 A. represents actively composting mass, whether it be in any sort of vessel, windrows, or other shape pile covering a few square yards, or acres, B. Represents a heat exchanger, C. Represents a blower, in FIG. 1, pulling the air through both the compost and the heat exchanger. The blower can just as easily be located between the compost and the heat exchanger. The location of the blower is not critical to the process, as long as the blower moves the air through the compost, and the heated off gas from the compost is then routed through the heat exchanger. D. is a blower or pump that moves any kind of gas, air, or fluid through the secondary side the heat exchanger. E. Represents the heated air, gas or fluid coming out the secondary of side the heat exchanger; F Represents a drain to take off condensate from the cooling off-gas from the compost, which would otherwise flood the heat exchanger, and block the flow of compost heated off gas from the forced aeration; G Represented as a diamond, is a valve or other means of regulating the rate of air flow through the compost to , enable providing oxygen for the microbes, and not excessively cooling the compost below the temperature range for the microbes that are doing the decomposing, and, in the process, generating the heat. The outlined arrows represent the movement of the primary air from the forced aeration coming though the compost, then through the heat exchanger. The line arrows from D, to E, represent the flow of air, gas, or fluid going to and from the secondary side of the heat exchanger.

### DETAILED DESCRIPTION

The Invention is a process/method for capturing the Surplus Microbial Metabolic Heat from aerobic composting. The off gas from forced aeration is directed through the primary side of a heat exchanger. Whether compost is in a vessel of any sort, or a pile on the ground covering a few square yards or acres does not affect the fundamental process. The heat exchanger, and any low points in ducts that carry the off-gas from the compost must have a means to drain off condensate from cooling off-gas from the compost. The drains consist of U tubes with the secondary side of the U being lower than the primary side by at least 2 times the air pressure moving the off-gas from the compost through the heat exchanger, and condensate in the bottom of the U to prevent air from moving through the drain. Another blower or pump, D in FIG. 1, moves air, gas or any other fluid through the secondary side of the heat exchanger, so that the fluid, E in FIG. 1, has been heated as it passed through the secondary side of the heat exchanger. The rate of air flow through the compost is regulated by a valve, G in FIG. 1, to enable balancing the heat extracted with the rate of Surplus Microbial Metabolic Heat being generated by the microbes doing the composting.

1. A method for capturing surplus microbial heat from compost, comprising of: a. forced aeration system to move fresh air through the compost, providing oxygen for the microbes, and removing excess heat from the compost, With the forced air, after it has passed through the hot compost being routed through the primary side of a heat exchanger, drains located at all low points of the air ducts and said heat exchanger, to enable draining off condensate from the cooling of the off gas, to prevent the condensate from flooding the system and blocking the air flow, means of adjusting the rate of air flow through the compost, to enable matching cooling caused by the forced aeration to the rate that the microbes are generating surplus metabolic heat.
